(19) United States
(12) Patent Application Publication
(10) Pub. No.: US 2021/0167394 A1
(43) Pub. Date: Jun. 3, 2021

(54) PROTECTIVE LAYERS FOR BATTERY ELECTRODES

(71) Applicant: Cornell University, Ithaca, NY (US)

(72) Inventors: Lynden A. Archer, Ithaca, NY (US); Zhengyuan Tu, Nanchang (CN); Snehashis Choudhury, Ithaca, NY (US); Shuya Wei, Sanmenxia (CN); Qing Zhao, Ithaca, NY (US); Dylan Vu, Ithaca, NY (US)

(21) Appl. No.: 16/644,734

(22) PCT Filed: Jun. 20, 2018
(86) PCT No.: PCT/US2018/038434

§ 371 Date: Mar. 5, 2020

Related U.S. Application Data
(60) Provisional application No. 62/572,943, filed on Oct. 16, 2017.
(60) Provisional application No. 62/556,037, filed on Sep. 8, 2017.

(51) Int. Cl. H01M 4/62; H01M 4/36; H01M 4/38; H01M 10/052; H01M 10/0567

(52) U.S. Cl. CPC H01M 4/628; H01M 4/366; H01M 2300/0025; H01M 10/052; H01M 10/0567; H01M 4/382

(57) ABSTRACT

Rechargeable batteries are disclosed having a protective membrane layer on surfaces of an electrode such as cathode active material. Such membranes include anionically charged groups and include an anionic membrane or a zwitterionic membrane. Such membranes can minimize contact of electrolyte to the surfaces of the active materials of the cathode where oxidation of electrolyte typically occurs thus promoting thermal stability of the electrolyte especially for high voltage batteries.

### CROSS-REFERENCE TO RELATED APPLICATIONS

This application claims the benefit of U.S. Provisional Application Nos. 62/556,037 filed 8 Sep. 2017, and 62/572,943, filed 16 Oct. 2017, the entire disclosures of each of which are hereby incorporated by reference herein.

### STATEMENT REGARDING FEDERALLY SPONSORED RESEARCH

This invention was made with government support under grant numbers DMR-1609125 and DMR-1120296 awarded by the National Science Foundation and grant numbers DE-AR0000750 and DE-FOA-001002-2265 awarded by the Department of Energy. The government has certain rights in the invention.

### TECHNICAL FIELD

The present disclosure relates to a metal-based rechargeable battery having a membrane on an electrode of a battery cell such as the active material of the cathode electrode. Such membrane coatings can be prepared from anionic materials, zwitterionic materials or precursors which form such membranes.

### BACKGROUND

High energy rechargeable batteries based on active metal (Li, Na, Al, Si, Sn, Zn, etc.) anodes are among the most important electrochemical energy storage devices to supply power for rapidly evolving technologies, including the fields of portable electronics, advanced robotics, electrification of transportation, etc. It has long been understood that such metal based anodes offer factors of 2-10 times higher specific capacity (e.g., 3860 mAh/g for Li), compared with the carbonaceous anode (360 mAh/g) used in lithium ion battery technology. Some metal anode batteries are also advantageous because they enable the development of high-energy unlithiated materials, such as sulfur, oxygen, and carbon dioxide as the active species in the cathode. This raises the prospect of multiple battery platforms that offer large improvements in specific energy on either a volumetric or mass basis.

Despite their promise, rechargeable batteries based on lithium (Li) metal, sodium (Na) metal, and aluminum (Al) anodes are not commercially viable today because the metals are plagued by one or more instabilities. Chemical instability of the metal in contact with liquid and solid-state ceramic electrolyte depletes the electrolyte and electrode overtime, leading to run-away increases in cell resistance. At low current densities, spatial heterogeneities in the conductivity of spontaneously formed, fragile solid electrolyte interphases (SEIs) on Li lead to rough plating of the metal during battery recharge as electric field lines concentrate on thinner, more conductive SEI that provide faster growth leading to the morphological instability typically associated with mossy, high-surface-area deposits. At high current densities, depletion of ions from an electrochemically active surface leads to formation of the hydrodynamic instability termed electroconvection, which drives selective metal deposition at localized regions on the electrode to form diffusion limited fractal structures termed dendrites. Because the driving force for the last of these three instabilities is physical, all batteries based on charge storage by reduction of metal ions at the anode (e.g. Li, Na, Al) will fail by this mechanism at high currents.

Uncontrolled growth of metallic structures created as a result of morphological or hydrodynamic instabilities leads to battery failure by formation of internal shorts, which limits the cell lifetime. Even if this failure mode can be prevented through choice of electrolyte additives the chemical and physical fragility of the formed structures cause cell failure by other means, typically loss of active material in the anode, which manifests as a low charge utilization or Coulombic efficiency. Additionally, because Li-ion cells based on high-energy metallic anodes including Si, Sn, and Ge store Li by alloying reactions, which produce large cyclic volume change in the electrode and destroys the SEI formed on the electrode each cycle, the first of the three instabilities are common to Li-ion batteries based on any of these chemistries.

The main hurdles preventing large-scale deployment of batteries based on metal anodes stem from the uneven electrodeposition of metal ions during battery recharge and parasitic reactions between the metal anode and liquid electrolytes during all stages of battery operation. For example, batteries based on lithium or sodium are well-known to form rough, dendritic structures upon being reduced as a result of their intrinsic tendency to deposit on protrusions where the electric field lines are concentrated. Accumulated dendritic deposits can connect two electrodes, causing short-circuit and other safety-related hazards. In less extreme cases, dendrites promote the parasitic reaction of metal and the electrolyte which lowers the Coulombic efficiency and deteriorates the battery performance over time. This can be a more severe problem in a capacity balanced ‘full cell’ in which very limited amount of the metal species are present, in contrast with lab-based ‘half-cell’ where usually excessive metal anodes are used.

Further, electrolytes based on small-molecule ethers and their polymeric counterparts are known to form stable interfaces with alkali metal electrodes and for this reason are among the most promising choices for rechargeable lithium batteries. Uncontrolled anionic polymerization of the electrolyte at the low anode potentials and oxidative degradation at the working potentials of the most interesting cathode chemistries, however, have led to a concession in the field that solid-state or flexible batteries based on polymer electrolytes can only be achieved in cells based on low- or moderate-voltage cathodes.

Hence, there is a continuing need to develop high voltage rechargeable batteries that can stably cycle over long periods.

### SUMMARY OF THE DISCLOSURE

An advantage of the present disclosure is stable high voltage rechargeable batteries. Rechargeable batteries of the present disclosure comprise an anode electrode and a cathode electrode wherein at least one electrode comprises a protective coating formed of a membrane including anionically charged groups. For example, cathode electrode can comprise an active material which has the membrane coating on surfaces thereon and wherein the membrane comprises anionically charged groups. Such membranes, while allowing ion permeability, minimize contact of electrolyte to the surfaces of the active materials of the cathode where oxidation of the electrolyte typically occurs thus promoting thermal stability of the electrolyte especially during high voltage operation of the battery.

These and other advantages are satisfied, at least in part, by rechargeable battery comprising an anode electrode, a cathode electrode and an electrolyte, wherein at least one electrode, e.g., the cathode electrode, comprises an active material which has a membrane coating on surfaces thereon and wherein the membrane comprises anionically charged groups. Such membrane coatings can be prepared from anionic materials, zwitterionic materials or precursors which form such membranes.

Another aspect of the present disclosure includes a high voltage rechargeable battery comprising: an anode, e.g., an alkali metal anode and a cathode which comprises an intercalating composite active material having a membrane layer on surfaces thereof in which the membrane has anionic groups. The high voltage battery can further comprise an electrolyte which includes: (i) an ether, polyether, carbonate ester electrolyte or combinations thereof and (ii) one or more chain transfer agents.

Yet another aspect of the present disclosure includes a method of preparing a cathode electrode for a rechargeable battery. The method can comprise forming a conformal membrane coating on surfaces of an active material of the cathode, wherein the membrane comprises anionically charged groups.

Embodiments for the foregoing rechargeable batteries or process of preparing a cathode electrode include any one or more of the following features, individually or combined. For example, some embodiments include wherein the anode comprises alkali metals such as substantially metallic lithium or substantially metallic sodium. Other useful metal anodes include Li, Na, Al, Zn, Sn, Si, Ge, Ga, In, and their alloys. In addition graphite, graphene, amorphous carbons, lithium titanate, and any other materials with equilibrium potential <2.5V vs. Li/Li+ can be used for the anode. In other embodiments, the cathode can comprise intercalating composite active materials. In further embodiments, the electrolyte can include an ether, polyether, carbonate ester electrolyte or combinations thereof. In yet other embodiments, the electrolyte can include one or more chain transfer agents.

In still further embodiments, membranes that comprises at least anionic groups such as an anionic membrane or a zwitterionic membrane can be used as the protective coating on surfaces of the active material of the cathode. Useful anionic membranes include polymers or oligomers having anionically charged groups such as a sulfonated tetrafluoroethylene based fluoropolymer-copolymer, e.g., a lithiated sulfonated tetrafluoroethylene (Nafion type polymer). Useful zwitterionic membrane can be formed from zwitterionic materials such as proteins, polymers including both anionic and cationic groups such anionic groups can include phosphate, carboxylate or sulfonate and such cationic groups can include as quaternary ammonium groups. Such zwitterionic membranes include, for example, phosphatidylcholine (PC), polybetaines, and polyampholytes. In certain embodiments, a conformal layer is formed on the surfaces of the cathode active material. Such membranes can be formed from low molecular weight polymers or oligomers, e.g., less than about 50,000 daltons, such as less than about 20,000 dalton and less than about 10,000 dalton, and less than about 5,000 daltons. The membrane coating can also be formed in situ of an assembled cell by including a membrane forming precursor such as lithium bis(oxalate)borate (LiBOB), with or without an ether. When present, a low molecular weight, e.g., less than about 1000 daltons, ether or polyether can covalently bond with the LiBOB to form a super structure material as the conformal membrane on surfaces of active materials of a cathode electrode. The conformal super structure material can be represented as Aₓ-B_{y}, wherein A has anionically charged groups from a borate-based compound, e.g., a lithium bis(oxalate)borate, a phosphor-based compound, a silicon-based compound, or combinations thereof, and B comprises an ether, wherein A is covalently bound to B with or without loss of CO₂, such as with or without loss of one or two CO₂, and x and y are independently an integer of 1, 2, 3, 4, or 5, for example. The protective layer can have a thickness varying from 10 nm, 50 nm, 100 nm, 1μm, 5μm, 20 μm, 40 μm, 60 μm, 80 μm to 100 μm and any interval therebetween. The coating method can be solvent casting, mechanical rolling/stamping, atomic layer deposition.

Advantageously rechargeable batteries of the present disclosure can stably operate at high voltages such as higher than 3.0V, e.g., at least about 3.5V, 3.8V, 4.0V and even at least about 4.2V, or 4.5V and can stably cycle over 100 cycles, 200 cycles, and even greater than 500 cycles and greater than 1000 cycles or 1500 cycles or higher than about 2000 cycles.

Additional advantages of the present invention will become readily apparent to those skilled in this art from the following detailed description, wherein only the preferred embodiment of the invention is shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

Reference is made to the attached drawings, wherein elements having the same reference numeral designations represent similar elements throughout and wherein:

FIGS. 1A-1D illustrate certain aspects of the present disclosure including how ac chain transfer agent can regulate polymerization at a Lithium anode and enables stable electrodeposition of Li. FIG. 1A is a schematic showing the cleavage sites for the diglyme and HFiP molecules illustrating how uncontrolled polymerization of diglyme is terminated by the CH(CF₃)₂⁺ radical. FIG. 1B shows a voltage profile for the electroplating and stripping of lithium metal at a current density of 1 mA/cm². The different numbers referenced in the legend represent the cycle number for which the profiles are shown. FIG. 1C is a plot showing the coulombic efficiency of a Li∥stainless steel asymmetric cell at a current density of 1 mA/cm² and capacity of 1 mAh/cm². The black circles are results for the diglyme electrolyte containing the HFiP chain transfer agent and the red triangles are corresponding results for the same electrolyte without the chain transfer agent. FIG. 1D is another plot showing the coulombic efficiency of certain embodiments of the present disclosure

FIGS. 2A-2E illustrate how immobilized anions at the cathode electrolyte interface can prevent glyme oxidation. FIG. 2A is a schematic showing the proposed mechanism by which the oxidation of ethers is inhibited by a cathode electrolyte interphase (CEI) composed of immobilized anions. FIG. 2B is a plot of a voltage profile for a lithium∥NCM cell using the diglyme-LiNO3-HFiP electrolyte at C/10 rate. FIG. 2C is a plot of a Voltage profile of Li∥NCM cell using the same base electrolyte, however the cathode is coated with a layer of lithiated Nafion (Lithion), and the measurements are performed at a C/5 rate. FIG. 2D is representative chemical structure of Lithion. FIG. 2E shows results from electrochemical floating point analysis of glyme electrolytes in Li∥NCM cells with/without a Lithion CEI. In these experiments the voltage is maintained for 24 hours at potenials ranging from 3.6V to 4.3V and the time-dependent current response measured. The black lines are results for uncoated NCM and blue is for NCM electrode with a Lithion CEI.

FIGS. 3A and 3B illustrate chemical structures for in-situ formation of anionic aggregates at cathode interface: FIG. 3A shows structures of plausible coupling products of BOB²⁻ and diglyme. Calculated reaction free energies (in eV) for the formation of anionic (green color) and neutral (red) dimers are presented. FIG. 3B shows some optimized geometries for the dimer and higher order coupling products of the BOB anion and diglyme molecule.

FIGS. 4A and 4B show results of stable cycling of high voltage lithium batteries in accordance with an aspect of the present disclosure. FIG. 4A is a plot of FTIR spectra illustrating the vibrational modes characteristic of the interfacial molecular species present at the NCM electrode after charging at constant voltage of 3.8V for 24 hours. The circles identify modes associated with oxalates. FIG. 4B is a plot of electrochemical floating point analysis of a lithium∥NCM electrochemical cell at various voltages. In these tests the voltages noted on the x-axis of the figure are maintained for 24 hours and the current response recorded. In part b and c, the red curves represent baseline electrolyte, while the black curves are for electrolytes containing 0.4 M LiBOB.

FIG. 4C shows a voltage profile for 5th, 50th and 100th cycles of Li∥NCM cycling using the diglyme electrolyte containing the chain transfer agent and 0.4 M LiBOB.

FIG. 4D shows discharge capacity retention and coulombic efficiency over 200 cycles for Li∥NCM cell using the diglyme electrolyte containing the chain transfer agent and 0.4 M LiBOB. A 50 μm thick lithium foil was used for the measurements, thus the anode to cathode capacity ratio is 5.

### DETAILED DESCRIPTION OF THE DISCLOSURE

In the following description, reference is made to the accompanying drawings that form a part hereof, and in which is shown by way of illustration specific embodiments which may be practiced. These embodiments are described in sufficient detail to enable those skilled in the art to practice the disclosure, and it is to be understood that other embodiments may be utilized and that structural, logical, and/or other changes may be made without departing from the scope of the present disclosure. The following description of example embodiments is, therefore, not to be taken in a limited sense.

Ranges of values are disclosed herein. The ranges set out a lower limit value and an upper limit value. Unless otherwise stated, the ranges include all values to the magnitude of the smallest value (either lower limit value or upper limit value) and ranges between the values of the stated range.

A typical rechargeable battery comprises an anode, separator, electrolyte (additive), and cathode. Rechargeable batteries of the present disclosure are preferably high voltage batteries, e.g., the operating voltage of each cell of the battery is greater than 3.0V vs. Li/Li⁺. In some aspects, the operating voltages of the cells of the batteries of the present disclosure are at least about 3.3V, such as at least about 3.5V, 3.8V, 4.0V or 4.2V or higher. Advantageously, such batteries can stably cycle more than 100 cycles, 200 cycles, and even greater than 500 cycles and greater than 1000 cycles or 1500 cycles or higher than about 2000 cycles.

Anodes according to the present disclosure include materials with equilibrium potential <2.5V vs. Li/Li+ such as metal anodes, e.g., alkali metals such as substantially metallic lithium or substantially metallic sodium. Other metal anodes include Li, Na, Al, Zn, Sn, Si, Ge, Ga, In, their alloys, and graphite, graphene, amorphous carbons, lithium titanate, and any other materials with equilibrium potential <2.5V vs. Li/Li+. The anode can be a foil, or a composite comprised of active material particles, conductive agents, and binders on a current collector. The surface or the anode can be coated with a layer of protective interphase. The separator can be can be polymeric or a ceramic porous membrane (e.g. polyethylene, polypropylene based porous membranes, glass fiber membranes, polymers that can be swollen by the electrolyte, etc.).

Electrolytes that are useful for batteries of the present disclosure include, for example, an ether, polyether, carbonate ester or combinations thereof. Such ethers can include diethylene glycol dimethyl ether (G2), triethylene glycol dimethyl ether (G3), tetraethylene glycol dimethyl ether (G4), or higher ordered oligomer or polymer version of polyethylene glycol in either liquid, gel, or solid state form. The ether or carbonate based electrolyte can be combined with or without other solvents such as dioxanes, sulfoxides, etc. The can also include a metal salt such as an alkali metal salt, e.g., lithium salts such as lithium nitrate, lithium bis(trifluoromethane)sulfonamide, lithium bis(fluoromethane)sulfonamide, lithium hexfluorophosphate, lithium hexfluoroarsenate, lithium halogen salts (lithium fluoride, chloride, bromide, and iodide), lithium bis(oxalato) borate, and their combinations. Typically, the electrolyte infused in the separator should render a room temperature ionic conductivity of at least about 5×10⁻⁴ S cm⁻¹ and have a boiling point above 120° C.

The electrolyte also should exhibit a Coulombic efficiency greater than 98% at a current density >0.25 mA cm−2 and a cycling capacity >0.25 mAh cm−2 for more than 500 cycles. The electrolyte can have additives such as FEC, VC, LiF, PFP, and derivatives. The additives help to achieve the stability of the electrolyte when in contact of active materials by preventing continuous polymerization. (Criteria, impedance change <200 Ohm cm−2 after 10 days.)

The cathodes of the present disclosure can be intercalating composite cathodes and preferably are high voltage cathodes such as lithium iron phosphate, sulfur, including lithium cobalt oxide, lithium manganese oxide, lithium nickel oxide, lithium nickel, cobalt, manganese oxide (with various element ratios), lithium nickel, cobalt, aluminum oxide, lithium vanadium oxide, (e.g. NCM, LMO, LCO) etc. The cathode is typically composed of an active material, conductive agent, and binders.

An advantage of the present disclosure is that surfaces of the active material are coated with a membrane that has good ionic conductivity but minimizes contact of the electrolyte with the surfaces of active material of the cathode where oxidation of the electrolyte typically occurs. Such a membrane can reduce oxidative degradation of the electrolyte and allow use of electrolytes that would otherwise degrade at high voltages. Hence, in an aspect of the present disclosure, a cathode electrode includes active material which has a membrane coating on surfaces thereon, wherein the membrane comprises anionically charged groups. In certain embodiments, the membrane forms a conformal on surfaces of an active material of the cathode. This can be helpful for intercalating composite cathode active materials (e.g. NCM, LMO, LCO) which tend to have complex electrolyte-electrode interfaces due to the porous nature of many such intercalating composite cathodes active materials. Membranes that are useful for coating surfaces of cathode active materials include membranes that comprises at least anionic groups such as an anionic membrane or a zwitterionic membrane (zwitterionic membranes have both anionic and cationic groups). Such membranes can form self-limiting cathode-electrolyte interfaces (CEI). Useful anionic membranes include polymers or oligomers having anionically charged groups such as a sulfonated tetrafluoroethylene based fluoropolymer-copolymer, e.g., a lithiated sulfonated tetrafluoroethylene (Nafion type polymer), etc. Useful zwitterionic membrane can be formed from zwitterionic materials such as proteins, polymers including both anionic and cationic groups such anionic groups can include phosphate, carboxylate or sulfonate and such cationic groups can include as quaternary ammonium groups. Such zwitterionic membranes include, for example, phosphatidylcholine (PC), polybetaines, and polyampholytes. Polybetaines include poly(2-methacryloyloxyethyl phosphorylcholine) (PMPC), poly(sulfobetaine methacrylate) (PSBMA), poly(carboxybetaine methacrylate) (PCBMA), etc. and polyampholytes are polymers having charged groups located on different monomer units. Other membrane coatings can be formed from lithiated perfluorinated polymers, perchlorinated polymers, metal oxides, nitrides, and others that remain stable at high voltages. As such the membrane forms a protective layer to shield the electrolyte from the active materials of the cathode

The membrane, e.g., protective layer, can be practiced either on the active material particles before manufacturing the composite electrode sheet, or on the already made electrode sheet. The protective interphase should have an interfacial resistance <500 Ohm cm⁻², and allow charging voltage to be higher than 3.0V such as at least about 3.5V, 3.8V, 4.0V and even at least about 4.2V, or 4.5V. The protective layer can have a thickness varying from 10 nm, 50 nm, 100 nm, 1μm, 5μm, 20 μm, 40 μm, 60 μm, 80 μm to 100 μm and any interval therebetween. The coating can be lithiated perfluorinated polymers, perchlorinated polymers, metal oxides, nitrides, and others that remain stable at high voltages. The coating method can be solvent casting, mechanical rolling/stamping, atomic layer deposition.

To be more effective, the membrane coating is on all surfaces of the cathode active material. This can be achieved by using a solution of the membrane forming material such that a substantial portion of membrane forming material, e.g., a polymer or oligomer comprising anionically charged groups, is dissolved in a solvent and the solvent is applied to the cathode active material. To have good solubility of the membrane forming material, it is preferable to use low molecular weight polymers or oligomers, e.g., less than about 50,000 daltons, such as less than about 20,000 dalton and less than about 10,000 dalton, and less than about 5,000 daltons. The membrane coating can also be formed in situ of an assembled cell by including a membrane forming precursor materials. For example, a superstructure can be formed as a conformal coating on surfaces of active cathode material by reacting component A, having or resulting in anionically charged groups, with an ether, B, to form a super structure material that can be represented as Aₓ-B_{y}, where a and y are independent integers of 1, 2, 3, 4, and/or 5, for example. In an aspect of the present disclosure, A can comprise comprises a borate-based compound, e.g., a borate-based compound with a metal cation or an ionic liquid cation, a phosphor-based compound, e.g., a phosphite-based compound, a phosphate-based compound, or a silicon-based compound, or combinations thereof, and B comprises an ether. For the material, A is covalently bound to B with or without loss of CO₂ and x and y are independently an integer from 1-5. The ether, B, can be a glyme, such as a diglyme, triglyme, polyalkyloxylate such as a polyethylene oxylate, polyethylene glycol dimethyl ether (PEGDME), etc. Additional compounds that are useful as the A group in the Aₓ-B_{y} superstructure layer on surfaces of active materials on cathode electrodes include a borate-based compound, e.g., a borate-based compound with a metal cation such as lithium difluro (oxalato) borate, lithium tetrafluoroborate, lithium (2,2,2-Trifluorethoxy)trimethoxyborate, tris(2,2,2-trifluoroethyl) borate, tris(trimethyl silyl) borate, lithium biscatecholatoborate, lithium (2,2,2-Trifluorethoxy)trimethoxyborate, lithium (trimethylsiloxy)trimethoxyborate, lithium (4-Pyridiloxy)trimethoxyborate, lithium (But-2-inoxy)trimethoxyborate, etc. Borates with ionic liquid cations can also be used, examples of which include, without limitation, 1-allyl-1-methyl-pyrrolidin-l-ium bis(oxalato)borate, 1,1-diallylpyrrolidin-1-ium bis(oxalato)borate, Triallyl(propyl)ammonium bis(oxalato)borate, 1-allyl-1-methyl-pyrrolidin-1-ium bis(oxalato)borate. Phosphates and silicates can also serve as the bonding agents similar to boron-based compounds for the A group. Such phosphates and silicates include, for example, dimethylphosphite, dimethylphosphate, trimethylphosphate, triphenylphosphate, tris(2,2,2-trifluoroethyl) phosphate, tris(trimethylsilyl) phosphate, lithium difluorophosphate, tris(2-butoxyethyl) phosphate, tris(dimethylsilyl) phosphate, 3-aminopropyltriethoxysilane, triethoxy(fluoro)silane. In an embodiment of the present disclosure, A can comprises a borate-oxalate such as a lithium bis(oxalate)borate, and B comprises an ether, wherein A is covalently bound to B, with or without loss of CO₂, such as with or without loss of one or two CO₂, and x and y are independently an integer of 1, 2, 3, 4, or 5 for example.

To further improve the stability of high voltage batteries, the electrolyte can also include one or more chain transfer agents such as fluorinated alkyl phosphate, e.g., tris(hexafluoro-isopropyl)phosphate (HFiP).

Various embodiments and their various combinations and examples of the present disclosure are provided below.

For example, small-molecule linear and cyclic ethers/glymes and their carbonate esters formed by reaction with carbon dioxide have emerged as the most important family of electrolytes for lithium batteries. These molecules are attractive for a variety of reasons, including their low viscosity and ability to coordinate with lithium ions, producing higher concentrations of mobile charge carriers than one would anticipate from classical theory, based on their dielectric constants alone. Macromolecular analogs, most notably polyethylene glycol dimethyl ether (PEGDME), have been reported to offer additional beneficial effects, including orders of magnitude higher mechanical modulus, low volatility and low flammability, making them attractive candidates for solid-state or flexible lithium batteries in a variety of form factors. A substantial body of work focused on charge carrier transport mechanisms in polyethers has shown that lithium ion mobility is coordinated with molecular motions and that charge carrier transport occurs predominantly in the amorphous phase of the materials where molecular mobility is highest. A less studied, but as important trait of ethers is the ease with which they can be electropolymerized at the reducing potentials at the lithium battery anode, as well as at the oxidizing potentials of the cathode. Almost nothing is known about how these processes can be regulated to produce self-limiting interphases and how fast ion transport at such interphases might be used to stabilize deposition at the Li anode.

Reduction of small-molecule ethers and carbonate esters at a lithium battery anode produces less mobile polymeric species by ring-opening and/or anionic chemistries. In favorable situations (e.g. at the graphitic carbon anode of state-of-the art lithium ion batteries) the reactions are self-limiting and produce a thin coating of a low-molar mass polymer-rich phase (interphase) at the electrode surface. This so-called solid-electrolyte interface (SEI) limits molecular access to the electrode surface and prevents continuous loss of electrolyte. The SEI is known to be a factor for stable, long-term battery operation, but almost nothing is known about how the tools of polymer chemistry can be used to harness it to achieve a similar electrochemical function at more unstable (chemical and morphological) alkali metal anodes. In cells that use lithium metal as anode, spontaneously formed interphases are in fact rarely self-limiting. Numerous studies have begun to appear that center on materials synthesis strategies for creation of specially designed self-limiting interfaces on such anodes using sacrificial, easily reduced species added to an electrolyte, or application of ion permeable coatings formed ex-situ.

At the intercalating composite cathodes (e.g. NCM, LMO, LCO) of greatest contemporary interest for lithium cells, electrolyte-electrode interfaces are not restricted to planes. Designing self-limiting interphases able to reduce/prevent electrolyte oxidation is therefore far more complex. Because ethers are particularly vulnerable to oxidative attack, a concession in the field is that ether- and polyether-based electrolytes cannot be used in practical electrochemical cells that employ high-voltage cathodes. As a consequence, solid-state ceramic electrolytes have emerged in recent years as the most promising candidates for all solid-state lithium batteries.

Here, we show the chemical processes responsible for uncontrolled interphase polymer chain growth at the anode and oxidative degradation of ethers at the cathode of a lithium cell and on that basis show that electrolytes based on ethers can be designed to overcome conventional limitations. We show in particular that inhibition of anionic polymerization of electrolytes based on chain transfer agents (CTAs) offer unusually high levels of interphase stability at a lithium metal anode. We further report that anionic species able to limit transport of polymer intermediates at the cathode are an integral component in designing self-limiting cathode electrolyte interfaces (CEIs) able to stabilize glymes at highly oxidizing electrode potentials. Taken together with recent work showing that polyethers in a variety of cross-linked configurations are able to inhibit rough, dendritic electrodeposition at a lithium metal anode during battery recharge, the results reported herein provide a path towards safe, cost-effective solid state and flexible batteries based on polymer electrolytes.

In one aspect of the present disclosure, an electrolyte and metal salt comprised of Bis(2-methoxyethyl) ether (diglyme) and a low-cost Lithium Nitrate (LiNO₃) salt are used. Diglyme is chosen as the simplest oligo-ether that offers the combination of a high boiling point (162° C.) and appreciable ion transport rate at ambient temperature to be of interest as an electrolyte for the lithium metal battery. The chemical structure of the electrolyte, including the ease with which the molecule can be electropolymerized at the cathode or anode of an electrochemical cell is shared with all ether-based liquid and solid polymer electrolytes, which means that the interfacial polymerization, oxidative breakdown, and transport characteristics of diglyme at electrodes are to a reasonable approximation representative of a much broader class of polymer electrolyte candidates. The LiNO₃ concentration in diglyme is systematically adjusted by varying the ratio, r, of Li⁺ cations to ether oxygen (EO) molecules in the electrolyte.

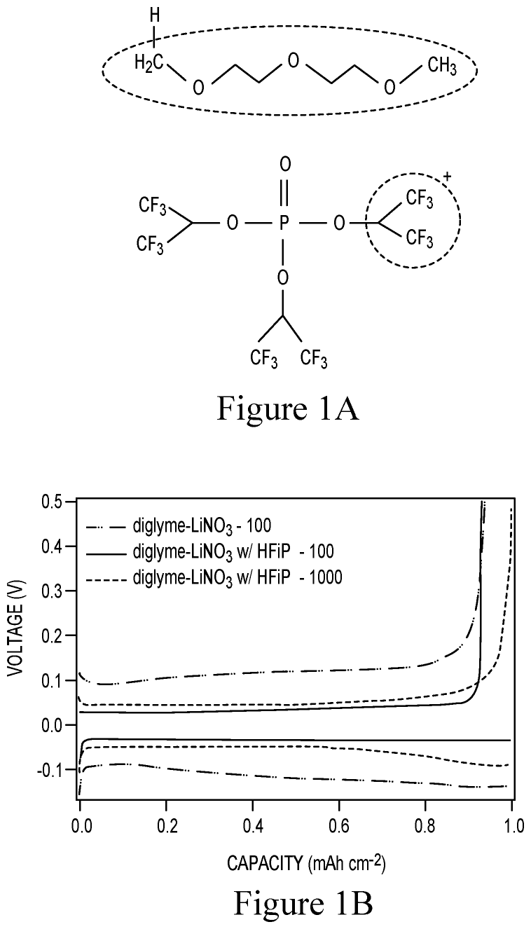

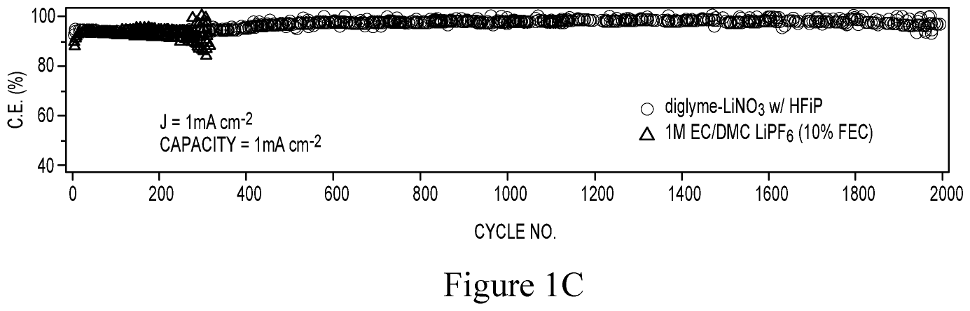

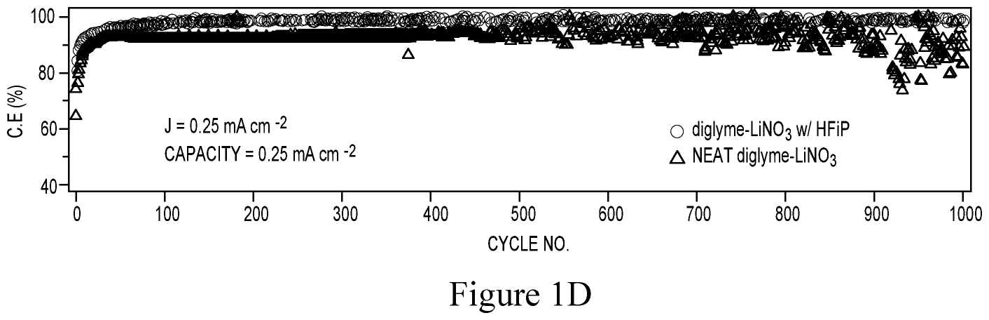

Experiments were conducted to determine the effect of r on the temperature-dependent electrolyte conductivity. The conductivity values at room temperature are seen exceed 1 mS/cm for all materials used in the study, but there are appreciable variations at sub-zero temperatures. It is clear from the results that diglyme-LiNO₃ electrolytes with r=0.1 exhibit the highest conductivity compared across the range of measurement temperatures employed in the study. It is also notable that even at temperature of −30° C., the conductivity of this electrolyte is >1 mS/cm, which makes it suitable for low-temperature battery operation without any compromise in power density. The activation energy, Eₐ, obtained from this analysis provides a measure of the facility with which ions move in an electrolyte plotted and are reported as a function of r in FIG. 1B. Ea is seen to increase monotonically with r, similar to the glass transition temperature (T_{g}), also plotted in FIG. 1B. This result indicates that there are high levels of molecular association between the diglyme and the salt and is consistent with the idea that as the salt concentration is increased, diglyme molecules move in a more coupled manner On the basis of these results, we utilize an electrolyte with r=0.1 for all subsequent studies.

Glyme or ether based electrolytes are known to undergo anionic polymerization at the surface of alkali metals, particularly at the highly reducing potentials at the anode. The resultant polymer-rich interphases are desirable because they passivate the electrode against parasitic chemical reactions with the electrolyte. Glymes are for this reason among the most preferred electrolytes for electrochemical cells in which alkali metals are to be used as anodes. The polymers formed may grow to such high molecular weights that Li+ transport to the electrode is severely retarded. Alkali metals are thought to initiate polymerization by cleaving a proton from the side-chain of a glyme molecule as shown in FIG. 1A. The polymer chain grows by an addition process wherein the active anionic reactive center collides with another glyme molecule, extending the length of the chain. Because electrostatic interactions between active centers prevent collisions between growing chains and centers can be stabilized by Li ions in solution, the growth can in principle progress indefinitely to produce extremely large, poorly conductive polymer chains or until all available glyme molecules are integrated into the growing center. In either event, ion mobility in the electrolyte bulk falls and interfacial resistance rises, producing premature failure of the cell by voltage run-away.

We hypothesize that an electrolyte that addresses this fundamental, termination-free characteristic of anionic addition polymerization could limit chain growth to produce self-limited SEI on a metallic electrode. To test this idea, we employ the molecule Tris(hexafluoro-iso-propyl)phosphate (HFiP) that is known to readily degenerate to form multiple CH(CF₃)₂⁺ species per molecule. The large number of electron withdrawing groups near the cationic fragments should enable rapid, and efficient quenching of anionic polymerization of glyme molecules by a chain transfer mechanism. As a proof of concept, we performed a simple analysis wherein lithium metal was dipped in a diglyme-LiNO₃-HFiP electrolyte for 5 days and analyzed the metal surface using X-ray Photoelectron Spectroscopy (XPS). From this analysis we observed the F-1s XPS has a single peak at 688.9 eV representing −CF3 bond, which is further confirmed from the C-1s XPS from the peak at 293.3eV.³¹ The absence of a metal-fluoride binding energy peak is a confirmation that the —CF3 groups do not decompose in the presence of the lithium metal electrode, ruling out an alternative stabilizing mechanism reported in our previous work.

The effectiveness of the approach to create self-limited interphases on a Li anode was evaluated in an asymmetric electrochemical cell comprised of lithium metal and stainless-steel electrodes. By comparing the electric current generated when a specific amount of Li is stripped from the Li electrode and deposited onto the stainless-steel electrode, with the current required for the reverse process, the coulombic efficiency (CE) of the cell can be determined. FIG. 1B shows the voltage profile during a typical measurement in cells with and without the HFiP chain transfer agent. It can be seen that although for the 100^{th} cycle the CE values for the two electrolytes are the same, the overpotential for stripping and plating Li are vastly reduced by the chain transfer agent, consistent with expectations for the CTAs ability to terminate polymer chain growth. The consequence of these effects is quite clearly seen in FIG. 1C and FIG. 1D, which report the CE for electrolyte with and without the CTA, at current densities of 1 mA/cm² and 0.25 mA/cm², respectively with each half cycle comprising of 1 hour. This means that approximately 5 μm and 1.25 μm of the 450 μm Li electrode is stripped and plated during each cycle, respectively. It is seen that the CE is maintained at a value >98% for 2000 plate-strip cycles, even without efforts to optimize the composition of the CTA in the electrolyte or its efficiency in terminating addition polymerization. This level of stability has to our knowledge not been observed in a lithium metal cell using a liquid electrolyte. The benefits of the CTA are obvious when results for electrolytes with and without this species are compared (FIG. 1C). It is observed that whereas the control diglyme-LiNO₃ electrolyte with/without the chain transfer agent have similar CE for the initial 200 cycles, upon longer-term cycling large fluctuations appear in the latter that are absent in the former. Similar behavior is observed at the lower current density of 0.25mA/cm², however the fluctuations in CE are seen after 500 cycles.

The fluctuations in CE observed in the control electrolytes are associated with the sporadic electrical connections with electrically disconnected fragments of lithium (‘orphaned lithium’) formed during the electrodeposition process and are indicative of the irreversibility of the process. These findings are confirmed by postmortem analysis of the electrode surface. Results from SEM analysis of the stainless-steel electrode show that after electrodeposition of 6 mAh/cm² (ca 30 μm of Li) at 1 mA/cm², in the glyme electrolyte containing HFiP the deposits are compact. In contrast, open, dendritic or needle-like structures are observed in the control electrolyte. This difference underscores the consequence of faster diffusion of lithium ions and low charge transfer resistance for the anodic reaction: Li⁺e⁻→Li at interphases where polymerization of the glyme is constrained.

The success of a CTA in limiting polymer growth under the reducing potentials at the Li anode lead us to hypothesize that an analogous approach might be used to enable all ether based electrolytes to be operated at higher potentials, where oxidative breakdown of the electrolytes is a well-known and longstanding barrier to ether-based electrolytes.

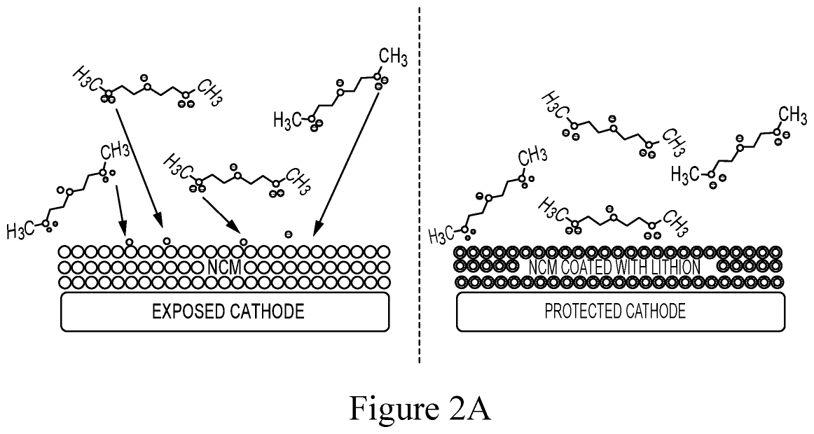

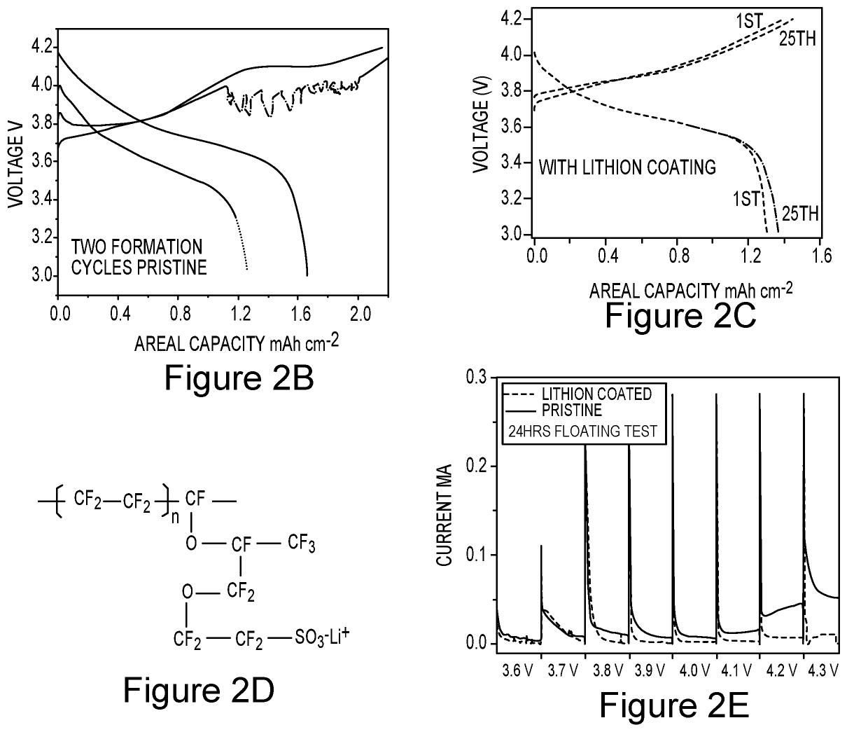

Because the cathodes of greatest contemporary interest are porous materials and the active polymer centers once initiated can in principle react with electrolyte solvent able to diffuse from any other location in the cell, a localized strategy that limits active center diffusion away from the electrode-electrolyte interface and lowers solvent migration to the active center is evidently needed. Here we chose to study interphases formed by the semi-crystalline anionic polymer electrolyte, Lithion (see FIG. 2A). This choice is motivated by three primary considerations. First, we discovered that solutions of Lithion in aprotic carbonate ester solvents possess sufficiently low viscosity that the polymer can be transported by liquid carriers into the pores of preformed cathodes. Second, the immobilized anions on Lithion can be thought to provide a barrier to oxidation reactions of the negatively charged species and Lewis bases in the electrolyte. We've previously explored electrokinetic attributes of this barrier and on that basis shown that the negative charge adopted by Lithion in solution provides an effective electrostatic shield that limits transport of negatively charged species at planar electrodes, yielding lithium transference numbers approaching unity in liquid electrolytes, Finally, the coexistence if hydrophobic and hydrophilic domains in Lithion means that at appropriate thicknesses it should be possible to retard molecular solvent transport, without compromising anion mobility.

To evaluate this concept, we studied electrochemical characteristics of a cell comprised of a lithium metal anode, NMC cathode and the base electrolyte (diglyme-LiNO₃-HFiP). As seen from FIG. 2A, the voltage profile exhibits a prolonged charging step in the 1^{st} cycle and erratic fluctuations in the 2^{nd} cycle above 3.8V vs. Li/Li⁺. The discharge step does not show such fluctuations, however a high overpotential is observed in the 2^{nd} cycle indicative of high battery resistance due to the oxidative degradation of glyme electrolytes and implying that the chain transfer agent in the electrolyte is ineffective in arresting degradation processes at the cathode. These results can be compared with observations provided in FIG. 2C where a solvent casting procedure was used to deposit an approximately 150 μm coating of lithiated nafion (lithion) (structure shown in FIG. 2D) throughout the NCM electrode. As seen from voltage profiles for the 1^{st} and 25^{th} cycles in FIG. 2C, the Li∥NCM cells do not show the prolonged charging characteristics observed for the controls. Electrochemical floating-point analysis was used to provide deeper insight into the mechanism(s) through which the Lithion coatings increase electrolyte stability in the cathode. In this experiment, Li∥NCM cells with and without the lithion coating are charged at voltages ranging from 3.6V to 4.3V in a step-wise ramp and the voltage maintained at a targeted value for a period of 24 hours. The leakage current obtained at each voltage is recorded and can be used to directly assess the importance of electrochemical degradation of electrolytes in the fully charged state. The results show that the leak current is always higher for the control cells (ie. without the Lithion electrode treatment) than for those that utilize a lithion-coated NCM electrode. In addition, it is seen that the leakage current for the neat NCM cell start to exceed the modified NCM based cell at a faster rate beyond 4V, which is also consistent with the low coulombic efficiency in the Li∥NCM half-cell cycling.

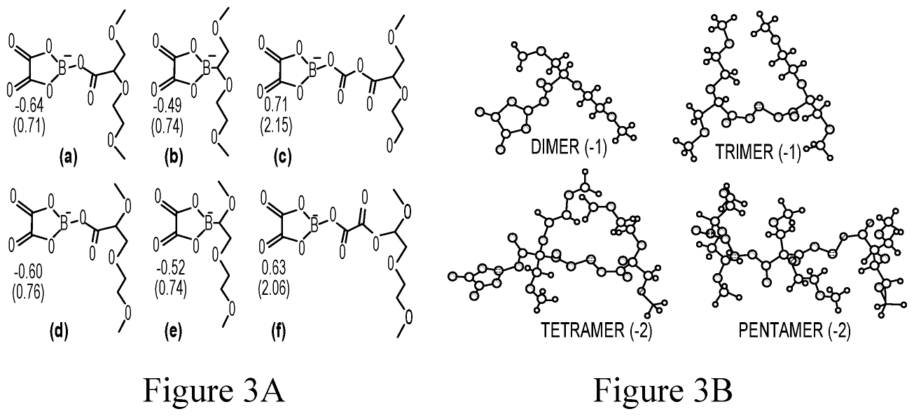

The effectiveness of the Lithion cathode coatings suggests that other approaches that lead to in-situ formation of anionic polymer coatings throughout the cathode would be a more straightforward strategy for enabling ether-based electrolytes in lithium cells employing high voltage cathodes. To evaluate this concept, we use the lithium salt bis(oxalate)borate (LiBOB) salt as and electrolyte additive in the base electrolyte and, by means of hybrid density functional theory (DFT), computationally study the interphases the salt forms at various electrode potentials. The BOB anion is of interest because it has been reported in previous studies to readily form either an open, dianion by breaking a B—O bond, or can furnish dissociation products. The reactions of these intermediate species with diglyme would generate distinct coupling products. We calculated the reaction free energies for the formation of a series of neutral and anionic O—C, C—C, and B—C coupling products from the diglyme and BOB dianion. These transformations proceed through the release of CO₂ molecules. Unique coupling products considered here and the respective free energy changes are presented in FIG. 3A. The calculations indicate that the formation of negatively charged species are thermodynamically more favorable than the respective neutral analogues. Among the anionic dimers, the C—C coupling product (a, FIG. 3A) formed by the release of a CO₂ molecule is thermodynamically most favorable (ΔG=−0.64 eV).

Starting from the negatively charged dimer, one could envision its subsequent reactions with diglyme and BOB²⁻, which will generate oligomers, polymers, or a supramolecular assembly at the electrode-electrolyte interface. We have calculated the reaction free energies for the step-wise generation of neutral or negatively charged dimer, trimer, tetramer, and pentamer from BOB²⁻ and diglyme. These calculations reveal that the formation of neutral or negatively charged trimer and higher aggregates is thermodynamically unfavorable. The formation of anionic and neutral forms of trimer from the dimer is endothermic by 1-4 eV, whereas the generation of higher order coupling products is highly unfavorable (ΔG>10 eV). At higher voltages, the trimers could still form, however it is very unlikely that further polymerization will occur. The higher oligomers with multiple charges may not be stable as they would readily dissociate to smaller charged dimers or trimers. The experiments have indicated that the negatively charged electrode-electrolyte interface prevents further reduction of diglyme. One possible reason is that, the layer of initially formed oligomers would form a network at the cathode via strong non-covalent interactions; furnishing a charged supramolecular assembly. This might be the reason for the prevention of further oxidation of diglyme at the cathode.

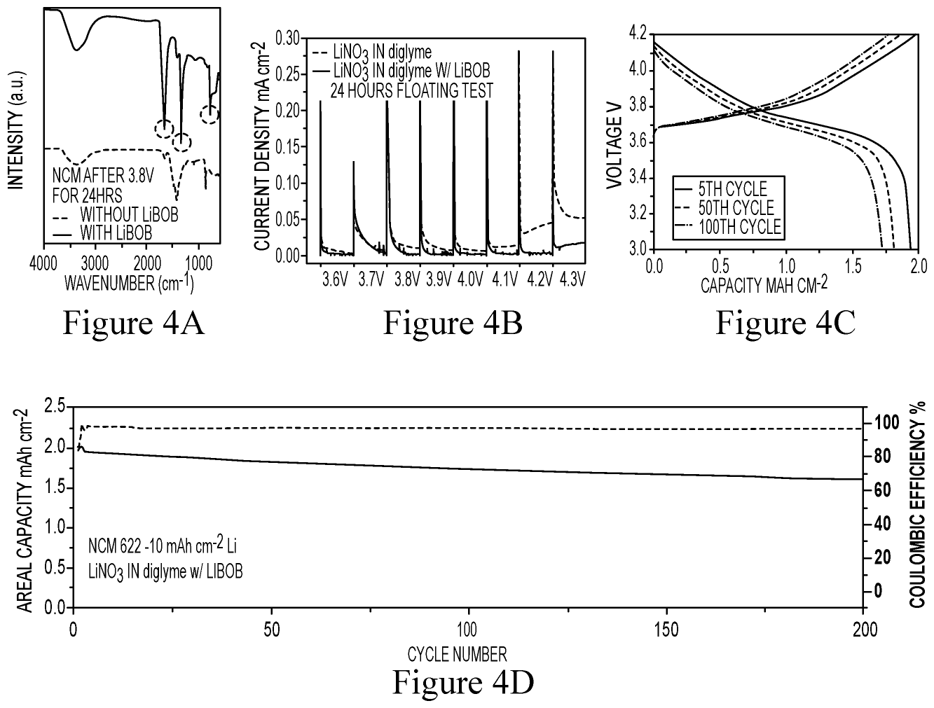

To experimentally interrogate the cathode-electrolyte interphase (CEI) formed in the presence of a LiBOB salt, we charged a Li∥NCM battery with and without LiBOB additive using a constant voltage operation at 3.8V vs. Li/Li+ and harvested the NCM cathode for FTIR analysis as shown in FIG. 4A. We observe three major peaks in the cathodic interphase with LiBOB additive at 775 cm⁻¹, 1330 cm⁻¹ and 1650 cm⁻¹, which can be assigned to the Li-oxalate peaks according to previous literature³⁶. On this basis, it can therefore be asserted that the interphase is dominated by the BOB-based molecules because of the sharp and high intensity oxalate peaks. To investigate the electrochemical properties of the cells, we performed electrochemical floating analysis in a Li∥NCM cell in electrolytes with/without the LiBOB additive. The results (FIG. 4D) show that the leak current for the cells containing LiBOB additive is lower than the control cells at all voltages. Finally, we cycle a lithium metal battery with the NCM cathode and a thin lithium anode (50 μm) such that the anode to cathode capacity ratio is 5:1 as shown in FIG. 5C and 5D. It is seen that coulombic efficiency of the cells is quite high (>98%) and that the discharge capacity is retained to more than 80% for at least 200 cycles.

In conclusion, we have demonstrated that cationic chain-transfer agents can be used to terminate anionic polymerization of ether-/glyme-based electrolytes at a lithium metal electrode, producing self-limiting interfaces, high Coulombic efficiency, and extend the lifetime of the anode (to over 4000 hours) in asymmetric lithium∥stainless steel cells. Building on these observations, we show that a longstanding barrier to deployment of glyme electrolytes can be removed using either ex- or in-situ generated interphases in the cathode that limit transport and reduce reactivity of active polymer centers by what we hypothesize to be an electrostatic shielding mechanism. Specifically, we show that a cathode electrolyte interphase (CEI) that hosts immobilized anions tethered to a polymeric backbone can act as a barrier for the oxidation reaction. Extending this concept to create an in-situ generated interphase composed of anionic polymer aggregates at the cathode result in significantly enhanced lifetime of a high voltage lithium metal battery. We believe, this work opens a new pathway for conventional, solid-state, and flexible lithium metal batteries based on ether and polyether-based electrolytes.

### EXAMPLES

The following examples are intended to further illustrate certain preferred embodiments of the invention and are not limiting in nature. Those skilled in the art will recognize, or be able to ascertain, using no more than routine experimentation, numerous equivalents to the specific substances and procedures described herein.

Computational Detail

All structures are optimized in the gas-phase using wB97X-D functional and 6-311G(d,p) basis sets implemented in the Gaussian suite of programs. Vibrational frequencies are calculated at the same level of theory to ensure that the optimized geometry represents a true minimum; i.e, no negative frequencies are found. Further, single point calculations are performed on these structures by employing a polarizable continuum model (PCM) to mimic the effects of diglyme. We used a dielectric constant of 7.23 for diglyme. A value of 1.63 eV is assumed for the electron solvation free energy.⁴²

Materials

Lithium discs were obtained from MTI corporation. Diglyme, Lithium Nitrate were all purchased from Sigma Aldrich. Tris(hexafluoroisopropyl) phosphate was obtained from Synquest Laboratories. Celgard 3501 separator was obtained from Celgard Inc. Lithion solution (LITHion™ dispersion, ˜10 wt % in isoproponal) was purchased from Ion Power Inc. The Lithion is composed of a nafion-type perfluorinated polymer having the sulfonic acid groups (EW ˜1100) ion exchanged by lithium ions. Nickel Manganese Cobalt Oxide (NCM) cathodes were obtained from from Electrodes and More Co. All the chemicals were used as received in after rigorous drying in a ˜0 ppm water level and <0.1 ppm oxygen glove box.

Coating of NCM Electrode with Lithion Solution

NCM electrodes were punched out using a hole-punch of diameter ⅜″. On a flat bench-top, the NCM cathodes were layed and ˜20 μl of Lithion solution was dropped to evenly cover the entire surface. Thereafter the electrodes were dried in open air for 6 hours, followed by rigorous drying in a vacuum oven at a temperature of 60° C. for 24 hours.

Scanning Electron Microscopy

Surface analysis of electrodeposited stainless-steel was done using SEM with the LEO155FESEM instrument. The sample was prepared by depositing 6 mAh cm⁻² in battery comprising of lithium vs. stainless-steel comprising of diglyme-LiNO₃-HFiP electrolyte and Celgard separator.

X-Ray Photoelectron Spectroscopy

XPS was conducted using Surface Science Instruments SSX-100 with operating pressure of˜2×10⁻⁹ torr. Monochromatic Al K-α x-rays (1486.6eV) with beam diameter of 1 mm were used. Photoelectrons were collected at an emission angle of 55°. A hemispherical analyzer determined electron kinetic energy, using pass energy of 150V for wide survey scans and 50V for high-resolution scans. Samples were ion-etched using 4 kV Ar ions, which were rastered over an area of 2.25×4 mm with total ion beam current of 2 mA, to remove adventitious carbon. Spectra were referenced to adventitious C 1 s at 284.5 eV. CasaXPS software was used for XPS data analysis with Shelby backgrounds. Samples were exposed to air only during the short transfer time to the XPS chamber (less than 10 seconds).

Floating-Point Experiment

Floating-point experiments were performed in a cell comprising of lithium vs. NCM using various electrolytes reported in the main text. The batteries were charged at constant current of 0.4 mA cm⁻² up to different voltages from 3.6V to 4.3V and then held at a constant voltage for 24 hours and the values of the leak current at various voltages were measured.

Fourier Transform Infrared Spectroscopy

The NCM electrodes were harvested after constant voltage charge at 3.8V for 24 hours in a battery comprising of lithium anode and NCM cathode using the electrolyte of diglyme-LiNO₃-HFiP with and without LiBOB additive. After drying for 24 hours in the glove-box antechamber ATR-FTIR was used in the wavelength range of 800 cm⁻¹ and 4000 cm⁻¹.

Battery Performance

2032 type Li∥stainless-steel coin cells with and without HFiP additive in diglyme-LiNO₃ electrolyte were prepared inside an argon-filled glove box. The amount of electrolyte used for all battery testing was 60 μl. The cells were evaluated using galvanostatic cycling in a Neware CT-3008 battery tester. Coulombic Efficiency test was performed in Li∥stainless steel cell with different current densities with one each cycle comprising of one hour. Half-cell test was performed in Li∥NCM at a C-rate of 0.2C. The cathode loading was 2mAh/cm² and the voltage range was between 4.2V to 3V.

While the claimed invention has been described in detail and with reference to specific embodiments thereof, it will be apparent to one of ordinary skill in the art that various changes and modifications can be made to the claimed invention without departing from the spirit and scope thereof. Thus, for example, those skilled in the art will recognize, or be able to ascertain, using no more than routine experimentation, numerous equivalents to the specific substances and procedures described herein. Such equivalents are considered to be within the scope of this invention, and are covered by the following claims.

1. A rechargeable battery comprising an anode electrode, a cathode electrode and an electrolyte, wherein the anode electrode or cathode electrode comprises a membrane coating thereon and wherein the membrane comprises anionically charged groups.

2. The rechargeable battery of claim 1, wherein the cathode comprises an active material which has a membrane coating on surfaces thereon and wherein the membrane comprises anionically charged groups.

3. The rechargeable battery of claim 1, wherein the membrane comprises a lithiated sulfonated tetrafluoroethylene.

4. The rechargeable battery of claim 1, wherein the membrane comprises material Aₓ-B_{y}, wherein A has anionically charged groups from a borate-based compound, a phosphor-based compound, a silicon-based compound, or combinations thereof, and B comprises an ether, wherein A is covalently bound to B with or without loss of CO₂ and x and y are independently an integer from 1-5.

5. The rechargeable battery of claim 4, wherein the borate based compound is selected among lithium bis(oxalate)borate, lithium difluro (oxalato) borate, lithium tetrafluoroborate, lithium (2,2,2-trifluorethoxy)trimethoxyborate, tris(2,2,2-trifluoroethyl) borate, tris(trimethyl silyl) borate, lithium biscatecholatoborate, lithium (2,2,2-Trifluorethoxy)trimethoxyborate, lithium (trimethylsiloxy)trimethoxyborate, lithium (4-Pyridiloxy)trimethoxyborate, lithium (but-2-inoxy)trimethoxyborate, 1-allyl-1-methyl-pyrrolidin-1-ium bis(oxalato)borate, 1,1-diallylpyrrolidin-1-ium bis(oxalato)borate, triallyl(propyl)ammonium bis(oxalato)borate, 1-allyl-1-methyl-pyrrolidin-1-ium bis(oxalato)borate or combinations thereof.

6. The rechargeable battery of claim 4, wherein the phosphor-based compound is selected among dimethylphosphite, dimethylphosphate, trimethylphosphate, triphenylphosphate, tris(2,2,2-trifluoroethyl) phosphate, tris(trimethylsilyl) phosphate, lithium difluorophosphate, tris(2-butoxyethyl) phosphate, tris(dimethylsilyl) phosphate, or combinations thereof.

7. The rechargeable battery of claim 4, wherein the silicon-based compound is selected among 3-aminopropyltriethoxysilane, triethoxy(fluoro)silane, or a combination thereof.

8. The rechargeable battery of claim 1, wherein the metal anode comprises substantially metallic lithium.

9. The rechargeable battery of claim 1, wherein the electrolyte includes an ether, polyether, carbonate ester or combinations thereof.

10. The rechargeable battery of claim 1, wherein the electrolyte includes one or more chain transfer agents.

11. The rechargeable battery of claim 1, wherein the operating voltage of the battery is greater than 3.0V vs. Li/Li⁺.

12. The rechargeable battery of claim 11, wherein a discharge capacity of the battery is at least 80% for at least 200 cycles.

13. The rechargeable battery of claim 1, wherein the rechargeable battery has a coulombic efficiency exceeding 90%.

14. The rechargeable battery of claim 1, wherein the rechargeable battery can stably cycle over 1000 cycles.

15. The rechargeable battery of claim 1, wherein the rechargeable battery can stably cycle over 1500 cycles.

16. A high voltage rechargeable battery comprising:
an alkali metal anode;
a cathode which comprises an intercalating composite active material and having a membrane comprising at least anionic groups coated on surfaces of the active material; and
an electrolyte which includes: (i) an ether, polyether, carbonate ester or combinations thereof and (ii) one or more chain transfer agents;
wherein the rechargeable battery can stably cycle over 100 cycles at an operating voltage of greater than 3.0V.

17. The rechargeable battery of claim 16, wherein the alkali metal anode comprises substantially metallic lithium.

18. The rechargeable battery of claim 16, wherein the rechargeable battery can stably cycle over 1000 cycles.

19. The rechargeable battery of claim 16, wherein the rechargeable battery can stably cycle over 1000 cycles at an operating voltage of greater than 3.5V.

20. A method of preparing a cathode electrode for a rechargeable battery, the method comprising: forming a conformal membrane coating on surfaces of an active material of the cathode, wherein the membrane comprises anionically charged groups.

21. The method of claim 20, wherein forming the conformal membrane includes electropolymerizing one or more precursors in the electrolyte on to the surfaces of the active materials of the cathode.

22. The method of claim 21, wherein electropolymerizing the one or more precursors in the electrolyte on to the surfaces of the active materials of the cathode forms a membrane comprising material Aₓ-B_{y}, wherein A has anionically charged groups from a borate-based compound, a phosphor-based compound, a silicon-based compound, or combinations thereof, and B comprises an ether, wherein A is covalently bound to B with or without loss of CO₂ and x and y are independently an integer from 1-5

23. The method of claim 20, wherein forming the conformal membrane includes applying a solution including a membrane forming material on to the surfaces of the active material of the cathode.

24. The method of claim 20, further comprising assembling the cathode electrode in a high voltage rechargeable battery.
